(19) United States
(12) Patent Application Publication
(10) Pub. No.: US 2025/0159533 A1
(43) Pub. Date: May 15, 2025

(54) Basic Sensing by Proxy and Doze Mode for IEEE 802.11bf Communications

(71) Applicant: Apple Inc., Cupertino, CA (US)

(72) Inventors: Benedikt Schweizer, Munich (DE); Debashis Dash, San Jose, CA (US)

(21) Appl. No.: 18/945,310

(22) Filed: Nov. 12, 2024

Related U.S. Application Data
(60) Provisional application No. 63/598,221, filed on Nov. 13, 2023.

(51) Int. Cl. H04W 24/10; H04L 5/00; H04W 84/12

(52) U.S. Cl. CPC H04W 24/10; H04L 5/0053; H04W 84/12

(57) ABSTRACT

Wireless stations and access points may perform a wireless local area network (WLAN) sensing operation using a basic sensing by proxy (SBP) procedure driven by an SBP responder, in which case the sensing features associated with the SBP procedure are dictated by the SBP responder, or driven by an SBP initiator, in which case the sensing features are dictated by the SBP initiator. For an SBP responder driven SBP procedure, the SBP session may be requested with a reduced number of parameters that include number of respondents and maximum bandwidth. For an SBP initiator driven SBP procedure, suitable sensing responders may be identified and instructed prior to receiving a sensing request. The WLAN sensing session may be paused to enter doze mode during which no sensing frame exchanges take place between participating nodes and the WLAN sensing session does not expire and is not terminated, and may resume upon exiting doze mode.

### PRIORITY INFORMATION

This application claims the benefit of priority of U.S. Provisional Patent Application Ser. No. 63/598,221, titled “Basic Sensing by Proxy and Doze Mode for IEEE 802.11bf Communications”, filed on Nov. 13, 2023, which is hereby incorporated by reference as though fully and completely set forth herein.

### FIELD OF THE INVENTION

The present application relates to wireless communications, including wireless local area network (WLAN) sensing during wireless communications such as IEEE 802.11 communications, including IEEE 802.11bf communications.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards.

One popular short/intermediate range wireless communication standard is wireless local area network (WLAN). Most modern WLANs are based on the IEEE 802.11 standard (or 802.11, for short). WLANs are marketed under the Wi-Fi brand name. WLAN networks link one or more devices to a wireless access point, which in turn provides connectivity to the wider area Internet. In 802.11 systems, devices that wirelessly connect to each other are referred to as “stations”, “mobile stations”, “user devices” or STA or UE for short. Wireless stations can be either wireless access points or wireless clients (or mobile stations). Access points (APs), which are also referred to as wireless routers, act as base stations for the wireless network. APs transmit and receive radio frequency signals for communication with wireless client devices. APs can also typically couple to the Internet in a wired fashion. Wireless clients operating on an 802.11 network can be any of various devices such as laptops, tablet devices, smart phones, or fixed devices such as desktop computers. Wireless client devices are referred to herein as user equipment (or UE for short). Some wireless client devices are also collectively referred to herein as mobile devices or mobile stations (although, as noted above, wireless client devices overall may be stationary devices as well).

WLAN sensing, currently under development by the IEEE 802.11 task group “BF” (IEEE 802.11bf) encompasses the use of Wi-Fi signals to perform sensing tasks by taking advantage of existing Wi-Fi infrastructures and ubiquitous Wi-Fi signals within surrounding environments. As WLAN sensing is being developed, there is a continued need for improvements.

### SUMMARY OF THE INVENTION

Embodiments are presented herein of, inter alia, of methods and procedures for a basic sensing by proxy (SBP) operation during wireless local area network (WLAN) sensing operations, and further for a Doze Mode of operation during which a WLAN sensing session is paused without expiring or being terminated. Embodiments are further presented herein for wireless communication systems containing at least wireless communication devices or user equipment devices (UEs) and/or access points (APs) communicating with each other within the wireless communication systems.

In some embodiments, wireless stations and access points may perform a wireless local area network (WLAN) sensing operation using a basic sensing by proxy (SBP) procedure driven by an SBP responder, in which case the sensing features associated with the SBP procedure are dictated by the SBP responder, or driven by an SBP initiator, in which case the sensing features are dictated by the SBP initiator. For an SBP responder driven SBP procedure, the SBP session may be requested with a reduced number of parameters that include a number of respondents and a maximum bandwidth. For an SBP initiator driven SBP procedure, suitable sensing responders may be identified and instructed prior to receiving a sensing request. The WLAN sensing session may be paused to enter Doze Mode during which no sensing frame exchanges take place between participating nodes and the WLAN sensing session does not expire and is not terminated, and may resume upon exiting Doze Mode

Note that the techniques described herein may be implemented in and/or used with a number of different types of devices, including but not limited to, base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an example WLAN communication system, according to some embodiments.

FIG. 2 illustrates an example simplified block diagram of a WLAN Access Point (AP), according to some embodiments.

FIG. 3A illustrates an example simplified block diagram of a mobile station (UE), according to some embodiments.

FIG. 3B illustrates an example simplified block diagram of an Internet of Things (IoT) station, according to some embodiments.

FIG. 4 shows an example frame structure for first action frames used during WLAN sensing operations, according to some embodiments;

FIG. 5 shows an example frame structure for second action frames used during WLAN sensing operations, according to some embodiments;

FIG. 6 shows an example table indicating an Extended Capabilities field, according to some embodiments;

FIG. 7 shows an example frame structure for fourth action frames used during WLAN sensing operations, according to some embodiments;

FIG. 8 shows an example frame structure for sixth action frames used during WLAN sensing operations, according to some embodiments;

FIG. 9 shows an example frame structure for seventh action frames used during WLAN sensing operations, according to some embodiments;

FIG. 10 shows an example frame structure for eighth action frames used during WLAN sensing operations, according to some embodiments;

FIG. 11 shows an example frame structure for ninth action frames used during WLAN sensing operations, according to some embodiments;

FIG. 12 shows an example frame structure for tenth action frames used during WLAN sensing operations, according to some embodiments;

FIG. 13 shows an example frame structure for eleventh action frames used during WLAN sensing operations, according to some embodiments;

FIG. 14 shows an example frame structure for twelfth action frames used during WLAN sensing operations, according to some embodiments;

FIG. 15 shows an example frame structure for thirteenth action frames used during WLAN sensing operations, according to some embodiments;

FIG. 16 shows an example frame structure for fourteenth action frames used during WLAN sensing operations;

FIG. 17 shows an example frame structure for fifteenth action frames used during WLAN sensing operations, according to some embodiments; and

FIG. 18 is a communication flow diagram illustrating a method for performing a basic sensing-by-proxy (SBP) procedure, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

Various acronyms are used throughout the present application. Definitions of the most prominently used acronyms that may appear throughout the present application are provided below:
UE: User Equipment
AP: Access Point
DL: Downlink (from AP to UE)
UL: Uplink (from UE to AP)
TX: Transmit/Transmission
RX: Receive/Reception
LAN: Local Area Network
WLAN: Wireless LAN
RAT: Radio Access Technology
STA: (Wireless) Station
PE: Privacy Enhanced
BSS: Basic Service Set
PLCP: Physical Layer Convergence Protocol
PSDU: PLCP Service Data Unit (Physical Layer Service Data Unit)
MPDU: Mac Protocol Data Unit
PPDU: Physical Protocol Data Unit
PHY: Physical (Layer)
DST: Destination (station or terminal)
RA: Receiver Address
TA: Transmitter Address
BA: Block Acknowledgment
TID: Traffic Identifier
MGMT: Management
MU: Multi User
AID: Association ID
EHT: Extremely Hight Throughput
OMI: Operation Mode Indication
UHR: Ultra High Reliability
STF: Short Training Field
LTF: Long Training Field
RU: Resource Unit
STF: Short Training Field
LTF: Long Training Field
U-SIG: Universal Signal
UHR-SIG: UHR Signal
L-SIG: Legacy (non-high-throughput) Signal
RL-SIG: Repeated Legacy (non-high-throughput) Signal
PE: Packet Extension
MUBAR: Multiuser Block Acknowledgement Request
QoS: Quality of Service
OFDMA: Orthogonal Frequency-Division Multiple Access

### Terms

The following is a glossary of terms that may appear in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—Includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems devices which perform wireless communications. Also referred to as wireless communication devices, many of which may be mobile and/or portable. Examples of UE devices include mobile telephones or smart phones (e.g., iPhone™, Android™-based phones) and tablet computers such as iPad™, Samsung Galaxy™, etc., gaming devices (e.g. Sony PlayStation™, Microsoft XBox™, etc.), portable gaming devices (e.g., Nintendo DS™, PlayStation Portable™, Gameboy Advance™, iPod™), laptops, wearable devices (e.g. smart watch, smart glasses), PDAs, portable Internet devices, music players, data storage devices, or other handheld devices, unmanned aerial vehicles (e.g., drones) and unmanned aerial controllers, etc. Various other types of devices would fall into this category if they include Wi-Fi or both cellular and Wi-Fi communication capabilities and/or other wireless communication capabilities, for example over short-range radio access technologies (SRATs) such as BLUETOOTH™, etc. In general, the term “UE” or “UE device” may be broadly defined to encompass any electronic, computing, and/or telecommunications device (or combination of devices) which is capable of wireless communication and may also be portable/mobile.

Wireless Device (or wireless communication device)—any of various types of computer systems devices which performs wireless communications using WLAN communications, SRAT communications, Wi-Fi communications and the like. As used herein, the term “wireless device” may refer to a UE device, as defined above, or to a stationary device, such as a stationary wireless client or a wireless base station. For example a wireless device may be any type of wireless station of an 802.11 system, such as an access point (AP) or a client station (UE), or any type of wireless station of a cellular communication system communicating according to a cellular radio access technology (e.g. 5G NR, LTE, CDMA, GSM), such as a base station or a cellular telephone, for example.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Processor—refers to various elements (e.g., circuits) or combinations of elements that are capable of performing a function in a device, e.g. in a user equipment device or in a cellular network device. Processors may include, for example: general purpose processors and associated memory, portions or circuits of individual processor cores, entire processor cores or processing circuit cores, processing circuit arrays or processor arrays, circuits such as ASICs (Application Specific Integrated Circuits), programmable hardware elements such as a field programmable gate array (FPGA), as well as any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band (or Frequency Band)—The term “band” has the full breadth of its ordinary meaning, and at least includes a section of spectrum (e.g., radio frequency spectrum) in which channels are used or set aside for the same purpose. Furthermore, “frequency band” is used to denote any interval in the frequency domain, delimited by a lower frequency and an upper frequency. The term may refer to a radio band or an interval of some other spectrum. A radio communications signal may occupy a range of frequencies over which (or where) the signal is carried. Such a frequency range is also referred to as the bandwidth of the signal. Thus, bandwidth refers to the difference between the upper frequency and lower frequency in a continuous band of frequencies. A frequency band may represent one communication channel or it may be subdivided into multiple communication channels. Allocation of radio frequency ranges to different uses is a major function of radio spectrum allocation. For example, in 5G NR, the operating frequency bands are categorized in two groups. More specifically, per 3GPP Release 15, frequency bands are designated for different frequency ranges (FR) and are defined as FR1 and FR2, with FR1 encompassing the 410 MHz-7125 MHz range and FR2 encompassing the 24250 MHz-52600 MHz range.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.

Station (STA)—The term “station” herein refers to any device that has the capability of communicating wirelessly, e.g. by using the 802.11 protocol. A station may be a laptop, a desktop PC, PDA, access point or Wi-Fi phone or any type of device similar to a UE. An STA may be fixed, mobile, portable or wearable. Generally in wireless networking terminology, a station (STA) broadly encompasses any device with wireless communication capabilities, and the terms station (STA), wireless client (UE) and node (BS) are therefore often used interchangeably.

Transmission Scheduling—Refers to the scheduling of transmissions, such as wireless transmissions. In some implementations of cellular radio communications, signal and data transmissions may be organized according to designated time units of specific duration during which transmissions take place. As used herein, the term “slot” has the full extent of its ordinary meaning, and at least refers to a smallest (or minimum) scheduling time unit in wireless communications. For example, in 3GPP LTE, transmissions are divided into radio frames, each radio frame being of equal (time) duration (e.g. 10 ms). A radio frame in 3GPP LTE may be further divided into a specified number of (e.g. ten) subframes, each subframe being of equal time duration, with the subframes designated as the smallest (minimum) scheduling unit, or the designated time unit for a transmission. Thus, in a 3GPP LTE example, a “subframe” may be considered an example of a “slot” as defined above. Similarly, a smallest (or minimum) scheduling time unit for 5G NR (or NR, for short) transmissions is referred to as a “slot”. In different communication protocols the smallest (or minimum) scheduling time unit may also be named differently.

Resources—The term “resource” has the full extent of its ordinary meaning and may refer to frequency resources and time resources used during wireless communications. As used herein, a resource element (RE) refers to a specific amount or quantity of a resource. For example, in the context of a time resource, a resource element may be a time period of specific length. In the context of a frequency resource, a resource element may be a specific frequency bandwidth, or a specific amount of frequency bandwidth, which may be centered on a specific frequency. As one specific example, a resource element may refer to a resource unit of 1 symbol (in reference to a time resource, e.g. a time period of specific length) per 1 subcarrier (in reference to a frequency resource, e.g. a specific frequency bandwidth, which may be centered on a specific frequency). A resource element group (REG) has the full extent of its ordinary meaning and at least refers to a specified number of consecutive resource elements. In some implementations, a resource element group may not include resource elements reserved for reference signals. A control channel element (CCE) refers to a group of a specified number of consecutive REGs. A resource block (RB) refers to a specified number of resource elements made up of a specified number of subcarriers per specified number of symbols. Each RB may include a specified number of subcarriers. A resource block group (RBG) refers to a unit including multiple RBs. The number of RBs within one RBG may differ depending on the system bandwidth.

Personal Area Network—The term “Personal Area Network” has the full breadth of its ordinary meaning, and at least includes any of various types of computer networks used for data transmission among devices such as computers, phones, tablets and input/output devices. Bluetooth is one example of a personal area network. A PAN is an example of a short-range wireless communication technology.

Bloom Filter—A Bloom filter is a space-efficient probabilistic data structure that may be used to determine whether an element is a member of a set. False positive matches are possible, but false negatives are not. Accordingly, a query returns either “possibly in set” or “definitely not in set” result. Elements may be added to but not removed from the set, which may be addressed with the counting Bloom filter variant; the more items added, the larger the probability of false positives.

TLV—Type-Length-Value or Tag-Length-Value) is an encoding scheme used for optional informational elements in a certain protocol. A TLV-encoded data stream contains code related to the record type, the record value's length, and finally the record value itself.

RU—Resource Unit is a unit in OFDMA terminology, used in, for example, 802.11ax WLAN, to denote a group of 78.125 kHz bandwidth subcarriers (tones) used in both downlink (DL) and uplink (UL) transmissions. With OFDMA, different transmit powers may be applied to different RUs. There may be a maximum of 9 RUs for 20 MHz bandwidth, 18 in case of 40 MHz and more in case of 80 or 160 MHz bandwidth. The RUs enable an Access Point (AP) station to be accessed by WLAN stations simultaneously and efficiently.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

The headings used herein are for organizational purposes only and are not meant to be used to limit the scope of the description. As used throughout this application, the word “may” is used in a permissive sense (e.g., meaning having the potential to), rather than the mandatory sense (e.g., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated. For example, a “third component electrically connected to the module substrate” does not preclude scenarios in which a “fourth component electrically connected to the module substrate” is connected prior to the third component, unless otherwise specified. Similarly, a “second” feature does not require that a “first” feature be implemented prior to the “second” feature, unless otherwise specified.

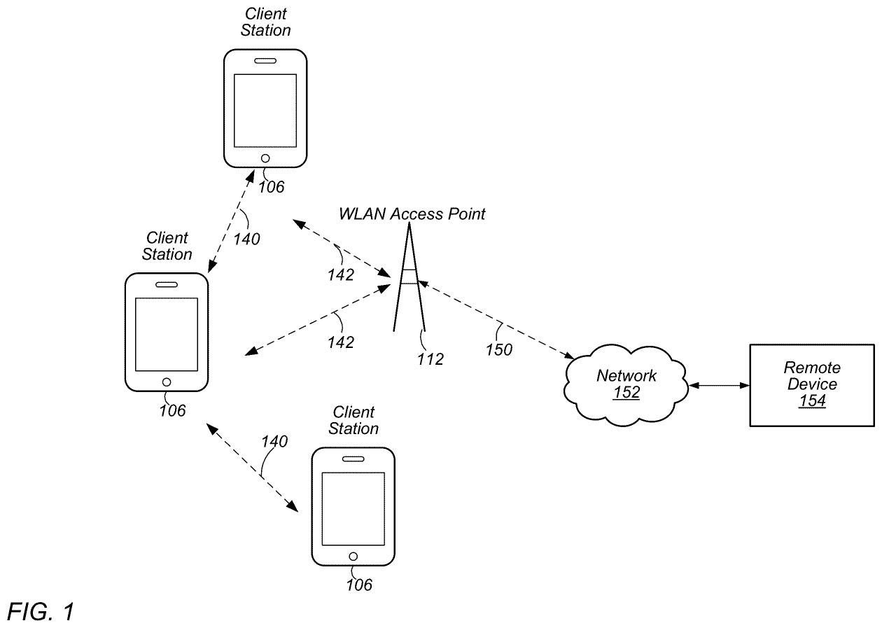

### FIG. 1—WLAN/WPAN System

FIG. 1 illustrates an example WLAN/WPAN system according to some embodiments. As shown, the exemplary WLAN/WPAN system includes a plurality of wireless client stations or devices, or user equipment (UEs), 106 that may communicate over a wireless communication channel 142 with an Access Point (AP) 112. The AP 112 may be a Wi-Fi access point. The AP 112 may communicate via a wired and/or a wireless communication channel 150 with one or more other electronic devices (not shown) and/or another network 152, such as the Internet. Additional electronic devices, such as the remote device 154, may communicate with components of the WLAN/WPAN system via the network 152. For example, the remote device 154 may be another wireless client station. The WLAN/WPAN system may operate according to any of various communications standards, such as the various IEEE 802.11 and IEEE 802.15 standards. Accordingly, in addition to communicating via AP 112, wireless devices 106 may communicate directly with one or more neighboring mobile devices (e.g., via direct communication channels 140), without use of the access point 112.

In some embodiments, operating features of a wireless device 106 may include basic sensing by proxy (SBP) features and may further include a Doze Mode of operation with its associated indications as disclosed herein.

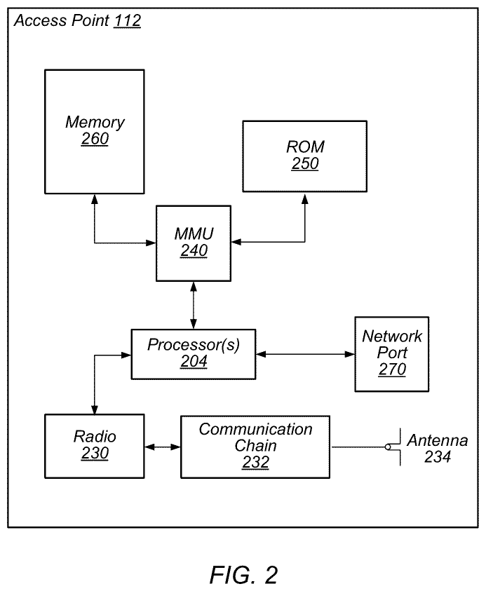

### FIG. 2—Access Point Block Diagram

FIG. 2 illustrates an exemplary block diagram of an access point (AP) 112. It is noted that the block diagram of the AP of FIG. 2 is only one example of a possible system. As shown, the AP 112 may include processor(s) 204 which may execute program instructions for the AP 112. The processor(s) 204 may also be coupled (directly or indirectly) to memory management unit (MMU) 240, which receive addresses from the processor(s) 204 and to translate those addresses to locations in memory (e.g., memory 260 and read only memory (ROM) 250) or to other circuits or devices.

The AP 112 may include at least one network port 270. The network port 270 may couple to a wired network and provide a plurality of devices, such as mobile devices 106, access to the Internet. For example, the network port 270 (or an additional network port) may couple to a local network, such as a home network or an enterprise network. For example, port 270 may be an Ethernet port. The local network may provide connectivity to additional networks, such as the Internet.

The AP 112 may include at least one antenna 234, which may operate as a wireless transceiver and may be further configured to communicate with mobile device 106 via wireless communication circuitry 230. The antenna 234 communicates with the wireless communication circuitry 230 via communication chain 232. Communication chain 232 may include one or more receive chains, one or more transmit chains or both. The wireless communication circuitry 230 may communicate via Wi-Fi or WLAN, e.g., 802.11. The wireless communication circuitry 230 may also, or alternatively, communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies. In some embodiments, operating features of AP 112 may include basic sensing by proxy (SBP) features and may further include a Doze Mode of operation with its associated indications as disclosed herein.

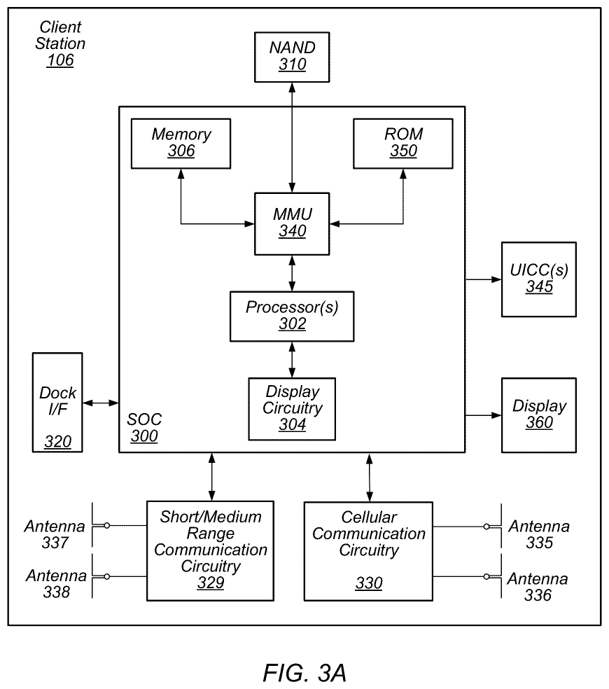

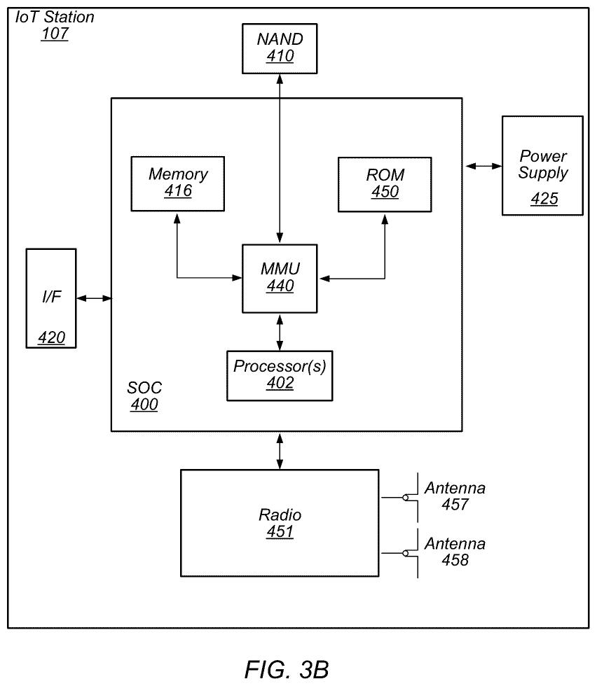

### FIG. 3A—Client Station Block Diagram

FIG. 3A illustrates an example simplified block diagram of a client station 106. It is noted that the block diagram of the client station of FIG. 3A is only one example of a possible client station. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, GSM, etc., and short to medium range wireless communication circuitry 329 (e.g., Bluetooth™ and WLAN circuitry). The client station 106 may further include one or more smart cards 310 that incorporate SIM (Subscriber Identity Module) functionality, such as one or more UICC(s) (Universal Integrated Circuit Card(s)) cards 345. The cellular communication circuitry 330 may couple to one or more antennas, such as antennas 335 and 336 as shown. The short to medium range wireless communication circuitry 329 may also couple to one or more antennas, such as antennas 337 and 338 as shown. Alternatively, the short to medium range wireless communication circuitry 329 may couple to the antennas 335 and 336 in addition to, or instead of, coupling to the antennas 337 and 338. The short to medium range wireless communication circuitry 329 may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, cellular communication circuitry 330, short range wireless communication circuitry 329, connector interface (I/F) 320, and/or display 360. The MMU 340 may perform memory protection and page table translation or set up. In some embodiments, the MMU 340 may be included as a portion of the processor(s) 302.

As noted above, the client station 106 may communicate wirelessly directly with one or more neighboring client stations. The client station 106 may be configured to communicate according to a WLAN RAT for communication in a WLAN network, such as that shown in FIG. 1. Further, in some embodiments, as further described below, client station 106 may perform methods for time sharing for multiple STAs on a single RU for a given transmission, for example in a DL OFDMA transmission.

As described herein, the client station 106 may include hardware and software components for implementing the features described herein. For example, the processor 302 of the client station 106 may implement part or all of the features described herein, e.g., by executing program instructions stored on a memory medium (e.g., a non-transitory computer-readable memory medium). Alternatively (or in addition), processor 302 may be a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 330, 335, 340, 345, 350, 360 may be configured to implement part or all of the features described herein.

In addition, as described herein, processor 302 may include one or more processing elements. Thus, processor 302 may include one or more integrated circuits (ICs) that perform the functions of processor 302. In addition, each integrated circuit may include circuitry (e.g., first circuitry, second circuitry, etc.) to perform the functions of processor(s) 204.

Further, as described herein, cellular communication circuitry 330 and short-range wireless communication circuitry 329 may each include one or more processing elements. In other words, one or more processing elements may be included in cellular communication circuitry 330 and also in short range wireless communication circuitry 329. Thus, each of cellular communication circuitry 330 and short-range wireless communication circuitry 329 may include one or more integrated circuits (ICs) that are configured to perform the functions of cellular communication circuitry 330 and short-range wireless communication circuitry 329, respectively. In addition, each integrated circuit may include circuitry (e.g., first circuitry, second circuitry, etc.) to perform the functions of cellular communication circuitry 330 and short-range wireless communication circuitry 329.

### FIG. 3B: Internet of Things (IoT) Station

FIG. 3B illustrates an example simplified block diagram of an IoT station 107, according to some embodiments. According to embodiments, IoT station 107 may include a system on chip (SOC) 400, which may include one or more portions for performing one or more purposes (or functions or operations). The SOC 400 may be coupled to one or more other circuits of the IoT station 107. For example, the IoT station 107 may include various types of memory (e.g., including NAND flash 410), a connector interface (I/F) 420 (e.g., for coupling to a computer system, dock, charging station, light (e.g., for visual output), speaker (e.g., for audible output), etc.), a power supply 425 (which may be non-removable, removable and replaceable, and/or rechargeable), and communication circuitry (radio) 451 (e.g., BT/BLE and/or WLAN).

The IoT station 107 may include at least one antenna, and in some embodiments, multiple antennas 457 and 458, for performing wireless communication with a companion device (e.g., client station 106, AP 112, and so forth) as well as other wireless devices (e.g., client station 106, AP 112, other IoT stations 107, and so forth). In some embodiments, one or more antennas may be dedicated for use with a single radio and/or radio protocol. In some other embodiments, one or more antennas may be shared across two or more radios and/or radio protocols. The wireless communication circuitry 451 may include WLAN logic and/or WPAN logic, such as BT/BLE logic, for example. In some embodiments, the wireless communication circuitry 451 may include multiple receive chains and/or multiple transmit chains for receiving and/or transmitting multiple spatial streams, such as in a multiple-input multiple output (MIMO) configuration.

As shown, the SOC 400 may include processor(s) 402, which may execute program instructions for the IoT station 107. The processor(s) 402 may also be coupled (directly or indirectly) to memory management unit (MMU) 440, which may receive addresses from the processor(s) 402 and translate those addresses into locations in memory (e.g., memory 416, read only memory (ROM) 450, NAND flash memory 410) and/or to other circuits or devices, such as the wireless communication circuitry 451. The MMU 440 may perform memory protection and page table translation or set up. In some embodiments, the MMU 440 may be included as a portion of the processor(s) 402.

As noted above, the IoT station 107 may be configured to communicate wirelessly with one or more neighboring wireless devices. In some embodiments, operating features of IoT station 107 may include basic sensing by proxy (SBP) features and may further include a Doze Mode of operation with its associated indications as disclosed herein.

### Wireless Local Area Network (WLAN)/Wi-Fi Sensing

Due to the significant and growing interest in WLAN sensing, also referred to as Wi-Fi sensing, Task Group IEEE 802.11bf was formed to develop an amendment to the IEEE 802.11 standard to enhance support for WLAN/Wi-Fi sensing and applications such as user presence detection, environment monitoring in smart buildings, and remote wellness monitoring, among others. Various sensing measurements performed as part of Wi-Fi sensing may be useful to estimate features of objects in an area of interest. Features may include range, velocity, angular, motion, etc. Objects may include humans, animals, inanimate large objects, etc. Areas of interest may include homes, enterprises, vehicles, etc.

In general, WLAN sensing or Wi-Fi sensing is a technology in which Wi-Fi signals are used to perform sensing tasks, by making use of Wi-Fi infrastructures and Wi-Fi signals in surrounding environments. Since Wi-Fi radio waves bounce, penetrate, and/or bend on the surfaces of objects during propagation, through proper signal processing, these received Wi-Fi signals may be used to sense surrounding environments, detect potential obstructions, and target movements. WLAN/Wi-Fi sensing has been used in various contexts, including gesture control, motion tracking, fall detection, activity recognition, imaging, monitoring of vital signs, and the like.

Wi-Fi sensing identifies three different procedures for sub-7 GHz operation/sensing, Trigger-Based (TB) Sensing, Non-Trigger-Based (Non-TB) Sensing, and Sensing by Proxy (SBP).

### Sensing by Proxy (SPB) for Wi-Fi Sensing

SBP allows a non-AP wireless station (STA; SBP initiator) to request an AP STA (SBP responder) to set up a TB Sensing Session on its behalf and, if requested, provide reports to the SBP initiator. SBP is therefore a valuable feature that allows the efficient and privacy-preserving realization of STA-side use cases. However, SBP is currently defined as an optional feature and it is questionable that it will be implemented due to high complexity, as encountered with regard to negotiation overhead (The SBP responder has to follow parameters provided by the SBP initiator and set up TB-Sensing sessions with suitable responders) and reporting overhead (The SBP responder has to process and/or combine multiple reports and forward the to the SBP initiator). In other words, while SBP is considered an essential feature to enable STA-side use cases, SBP is causing implementation overhead, linked to negotiation during session setup and also linked to reporting.

For example, there are many challenges encountered during setup. The AP has to identify responders. There are many options and features the SBP initiator can request from the sensing sessions. The AP has to negotiate parameters requested by the SBP initiator with sensing. Depending on the number of required responders and the requested parameter set, considerable amount of time and resources might be needed on the part of AP to set up the relevant sensing sessions for SBP.

There are also challenges associated with SBP reporting. The AP has to be able to collect and combine multiple reports from the sensing responders in the TB sensing session that is set up based on the SBP request. Depending on the number of responders, a decent amount of data may be created, and such data needs to be processed by the AP, possibly on higher layers and fed back to the physical layer (PHY) It may be difficult to implement these features an provide the information back to the SBP initiator while also providing normal communication operations.

To reliably enable client-side use cases, a basic SBP feature set may be defined. This basic SBP feature set may have limited complexity and put minimal demands on the AP by way of minimal negotiation overhead for sensing session setup and minimal reporting overhead. It may be advantageous to include such a feature set as a mandatory capability for AP Sensing STAs, i.e., of STAs sensing one or more APs.

In some embodiments, the Sensing by Proxy feature may split into a mandatory ‘Basic SBP’ feature and an optional ‘advanced SBP’ feature. The Basic SBP feature may offer two variants. In a first variant, in some embodiments, “opportunistic” SBP may be implemented (SBP responder driven), in which the sensing features are dictated (or defined) by the SBP responder. In a second variant, in some embodiments, “initiator-driven” SBP may be implemented, (SBP initiator driven), in which the sensing features are dictated (or defined) by the SBP initiator.

The ‘advanced SBP’ corresponds to the full-fledged SBP as defined in the current IEEE 802.11 specification and is not covered in further detail.

### Basic SBP—Opportunistic Variant

The SBP initiator may only request ‘an SBP session’ with a minimal parameter set e.g. (maximum) number of responders, maximum bandwidth. There is no list of preferred and/or mandatorily preferred responders and their roles.

To limit reporting overhead, the maximum refresh rate that is indicated in the availability window element may be limited, and the maximum sensing bandwidth may also be limited. Other parameters/features may be restricted in a similar way, e.g., number of streams, Ng, Nb. The SBP Responder may decide on the reporting details. All other parameters and/or operating options may be left to be implemented in the SBP Responder and/or SPB Sensing Initiator. This basic variant may be referred to as “opportunistic” since the SBP initiator has only minimal influence on what it receives from the SBP responder.

### Basic SBP—Initiator-Driven Variant

The Initiator-Driven variant may be based on various assumptions, as follows. The SBP initiator may have a mechanism in place to determine/identify suitable sensing responders and instruct them accordingly prior to the responders receiving the 11bf sensing request from the sensing initiator. This may be realized using any communication protocol (which may be proprietary, as warranted) and network, e.g., device-to-device communication. All responders may participate in the initiated TB sensing session. Sharing of results may happen over the cloud and/or according to an appropriate protocol, e.g., a proprietary protocol.

For the initiator-driven variant, the SBP initiator may provide a complete set of parameters as defined in a SBP Parameters element and Sensing Measurement Parameters element, e.g., a list of responders (e.g., mandatorily preferred responders), bandwidth, and/or availability window. The requested parameters may be a subset of the AP's capabilities. Reporting may not be mandatorily supported/implemented (but neither is it proscribed). If the SBP responder is not able to set up a session with these settings, e.g., if one sensing responder rejects the sensing request, the SBP responder may reject the SBP request.

It is useful to simplify SBP with a mandatory set of two basic SBP features that serve most of the needs of different use cases, but with drastically reduced implementation complexity.

Basic SBP—Implementation Details according to Some Embodiments

A new field, “SBP Type” field, may be included in the SBP Parameters element or may be added as part of one of the fields in the SBP parameters element, to signal the type of SBP. The “SBP Type” field/parameter may include 2 bits defined as follows:
00: reserved
01: standard SBP
10: opportunistic SBP
11: initiator-driven SBP

However, the different SBP types may be matched to different bit combinations that differ from the ones shown above. For example, the assignments may also be as follows:
00: reserved
01: opportunistic SBP
10: initiator-driven SBP
11: standard SBP

In general, the bit values may simply be assigned to indicate the 3 different SBP types discussed above. In some embodiments, a single bit may be set up to indicate either Standard SBP or Basic SPB.

Alternatively, a new element (which may be of variable field length) may be added to the SBP Parameters element. The presence of this field may be indicated in the SBP Parameters Control field. Additional “reject reason” codes may also be added for SBP, such that the SBP responder may indicate a possible reason for the rejection. Reasons may include AP source limitation (not capable of fulfilling the specific request) and/or matching responders not found.

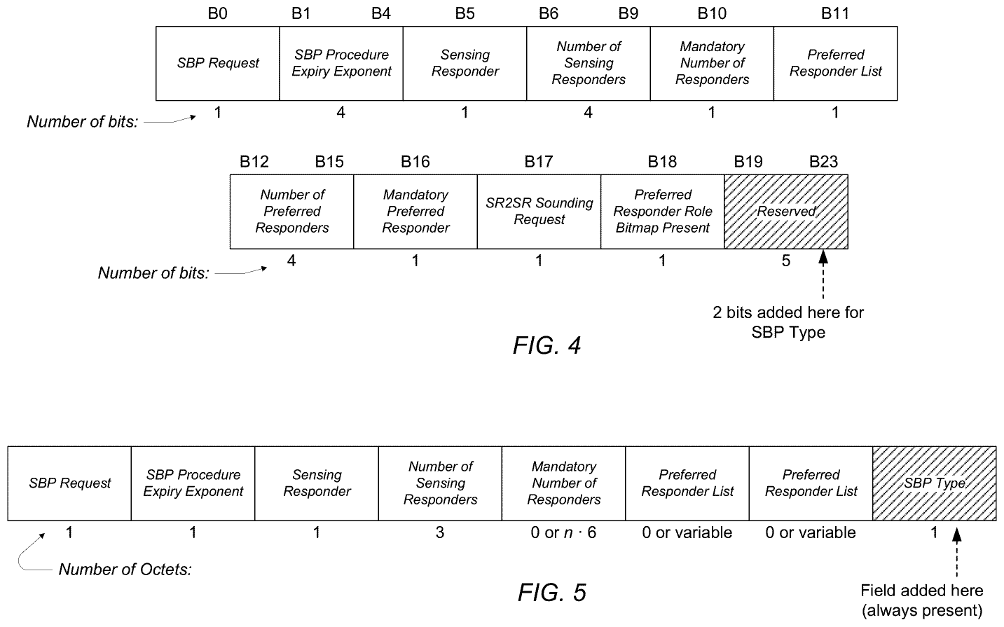

FIG. 4 shows an example diagram illustrating the SBP Parameters Control field format indicating the addition of a 2-bit SBP Type indicator in the Reserved field that spans bits 19-23.

FIG. 5 shows an example diagram illustrating the SBP Parameters Element format indicating the addition of a 2-bit SBP Type field following the Sensing Responder Role Bitmap field at the end.

### One-Variant Option

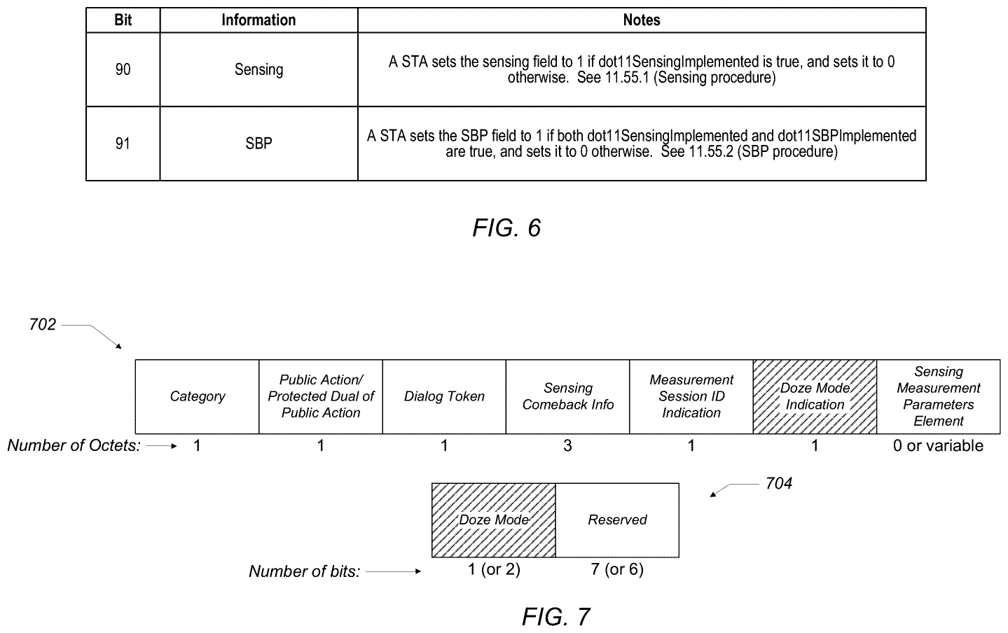

Depending on how a ‘Basic SBP feature’ is incorporated into the existing signaling standard, only one of the variants may be incorporated and used. This may be achieved, for example, by describing an XOR behavior (i.e., mandatory list XOR reporting). The feature may then be implemented without explicit signaling of ‘Basic SBP’ in the SBP Parameters element. In such a case it may be advantageous to signal ‘advanced/full SBP implemented’ in the Extended Capabilities field illustrated in FIG. 6. FIG. 6 shows an example diagram illustrating the Extended Capabilities field, in which bit 91 (SBP) may then refer to ‘advanced SBP’

### Doze Mode for Wi-Fi Sensing

In the current IEEE 802.11bf Draft 2.0, measurement periodicity is defined via availability windows that are exchanged during session setup. As a consequence, periodicity cannot be modified after a sensing session is established. Changing the periodicity would require the termination and reestablishment of a sensing session. Yet, the initiator has some flexibility to change the periodicity by omitting transmission of sensing frames during an availability window. This is acceptable for ‘normal’ Trigger-Based (TB) and Non-Trigger-Based (Non-TB) sensing sessions, where the application usually resides within the initiator that controls the session. In contrast, for Sensing by Proxy (SBP) sessions, the application resides on the SBP initiator, whereas the SBP responder is in control of the corresponding TB sensing session.

To put it another way, parameters of a sensing session are defined during session setup, e.g., the periodicity via availability windows. This is especially problematic for SBP sessions where the application resides on the SBP initiator that is completely detached from the sensing initiator (that is the SBP responder). Consequently, there is no method in place for an SBP initiator to influence the polling/triggering of sensing responders by the SBP responder/sensing responders. As a result, the SBP initiator has to request the maximum performance that is probably much higher than needed by the SBP initiator, due to lack of flexibility. Alternatively, the SBP initiator might frequently terminate and re-initiate SBP sessions. This should be avoided as it puts a decent burden on the AP.

### Doze Mode Feature

The above-described issues may be alleviated and/or solved by introducing a “Doze Mode” feature for SBP and TB/non-TB sessions. The feature may enable pausing and resuming sensing sessions, which may implicitly allow changing the periodicity by utilizing two SBP sessions that are paused in an alternating fashion.

In some embodiments, a simple but efficient mechanism may be introduced to pause and resume SBP and sensing sessions in order to make efficient use of the spectrum and resources at the participating nodes, avoid frequent termination and reinitiation of sensing-sessions/SBP-sessions, and to allow the application (on SBP initiator) to have better control over the sensing sessions. Potentially, the concept may allow changing the periodicity by using two SBP sessions with different respective periodicities and putting one of the SBP sessions to sleep (or pausing one of the SBP sessions.)

While in Doze Mode, no sensing frame exchanges may take place between the participating nodes, and the session may not expire or may not be terminated. This concept may be equally applicable to non-SBP sessions as well, allowing sensing responders to doze during their availability window. The feature may be of special importance for a TB sensing session that is initiated to fulfill an SBP request.

To initiate/stop a doze state, sensing action frames with specific fields having been set are transmitted from sensing/SBP initiator to sensing/SBP responder. Doze state signaling options may include:
Option 1: Indication with one bit: if the corresponding field is set, the responder may go into sleep mode until it receives any other sensing frame;
Option 1.1: Indication with one bit: if the corresponding field is set, the responder may go into sleep mode until it receives the same frame again with the corresponding field not set;
Option 2: Indication with one bit: if the corresponding field its set, the responder changes the state upon reception (‘toggle mode’), and if the corresponding field is not set, there is no action (‘reserved’).
Option 3: Indication with two bits: the first bit indicates the purpose (Set Doze State), and the second bit defines the state (e.g., 1: Doze/0: Active) the receiver shall enter.

Suitable sensing Action frames may depend on the session type.
TB/Non-TB sensing session→Sensing Measurement Request frame, Sensing Measurement Response frame, Sensing Measurement Termination frame
SBP session→SBP Request frame, SBP Response frame, SBP Termination frame.

### TB/Non-TB Sensing Session

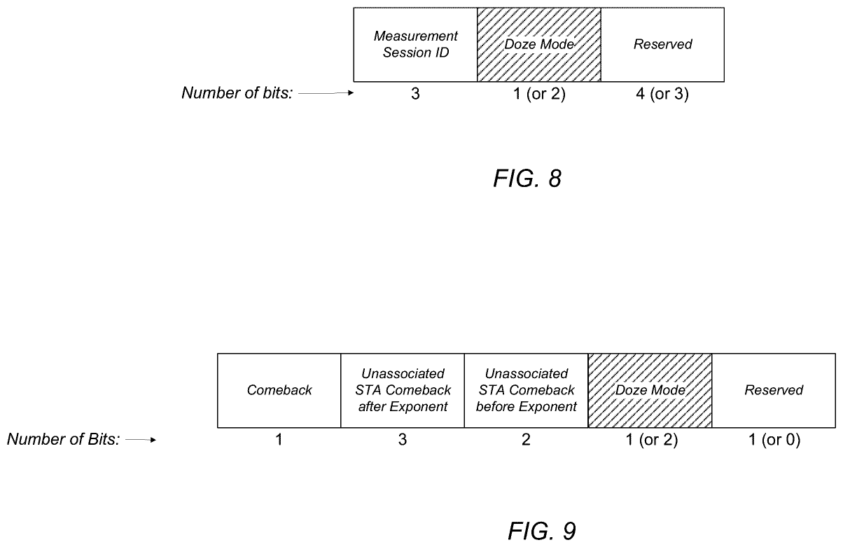

In some embodiment, a Sensing Measurement Request frame may be used for Non-TB and TB sensing. It may be transmitted by the sensing initiator and acknowledged by the sensing responder. The parameters (or parameter values) may correspond to the session that is paused, such that the sensing responder may identify the correct session. No Sensing Measurement Parameters element is needed for this frame exchange. To indicate ‘Doze Mode,’ a specific Doze Mode field (e.g., of 1 or 2 bits) may be added, as illustrated in FIGS. 7, 8, and 9. Each of FIGS. 7, 8, and 9 illustrates one possible option according to which a new “Doze Mode” field may be implemented. As illustrated in FIG. 7, the new “Doze Mode” field may be added within a new ‘Doze Mode’ Indication field within the Sensing Measurement Request frame Action field 702 (in reference to FIG. 9—1137a of the IEEE 802.11bf Draft 2.0 specification). The Doze Mode indication field format (for the Doze Mode field added in 702) is illustrated in 704. As illustrated in FIG. 8, the new “Doze Mode” field may be added within the Measurement Session ID Indication field (in reference to FIG. 9—1137a of the IEEE 802.11bf Draft 2.0 specification; this field may be renamed to Measurement Session Management field or a similar name expressing the extended functionality.) As illustrated in FIG. 9, the new “Doze Mode” field may be added within the Sensing Comeback Info field (in reference to FIG. 9—1137b of the IEEE 802.11bf Draft 2.0 specification.)

### SBP Session

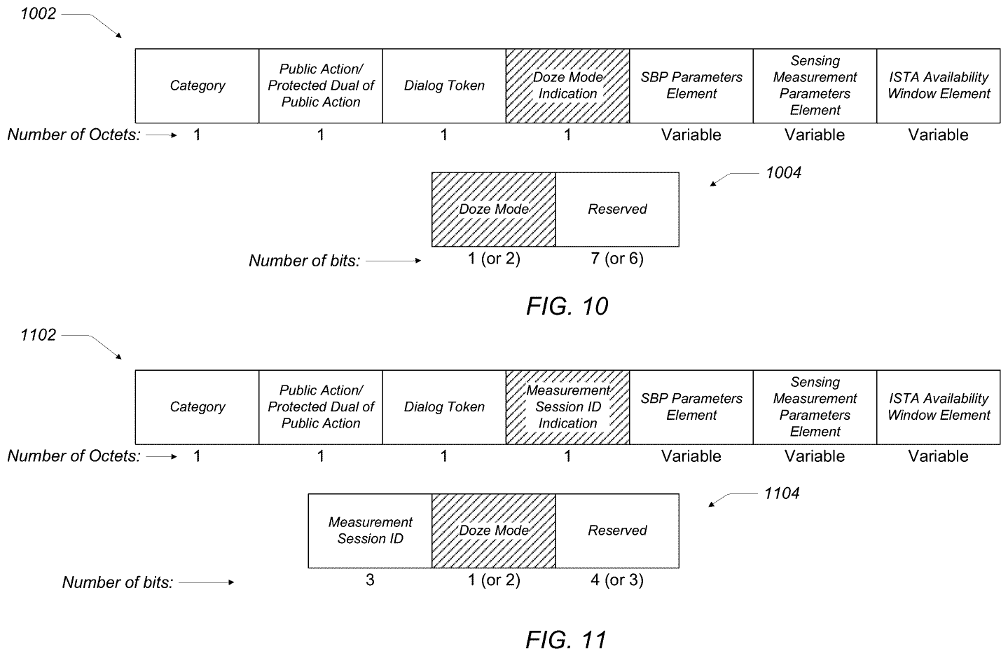

In some embodiments, an SBP Request frame may be used for SBP sessions. It may be transmitted by the SBP initiator and acknowledged by the SBP responder. The SBP responder may either identify the correct SBP session implicitly by exploiting the AID/USID of the SBP initiator, or explicitly by adding additional information that supports identification of the session, e.g., by adding the Measurement Session ID indication field (which, as previously noted, may be renamed to Measurement Session Management field or a similar name expressing the extended functionality.) To indicate ‘Doze Mode,’ a specific ‘Doze Mode’ field (e.g., of 1 or 2 bits) may be added, as illustrated in FIGS. 10 and 11. As illustrated in FIG. 10, the ‘Doze Mode’ indication may be added as a new Doze Mode Indication field within the SBP Request frame Action field 1002 (in reference to FIG. 9—1137j of the IEEE 802.11bf Draft 2.0 specification.) The Doze Mode indication field format (for the Doze Mode indication added in 1102) is illustrated in 1104. As illustrated in FIG. 11, a new ‘Doze Mode’ field may be added within the Measurement Session ID indication field 1104 (in reference to FIG. 9—1137c of the IEEE 802.11bf Draft 2.0 specification), which itself is added to the SBP Request frame Action field 1102 (in reference to FIG. 9—1137j of the IEEE 802.11bf Draft 2.0 specification).

### Additional Options: Use of Other Frames

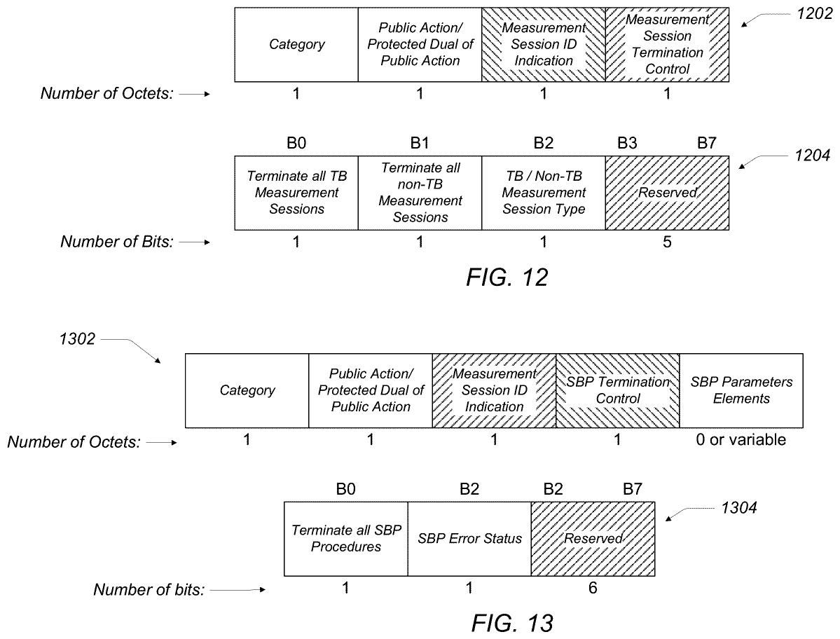

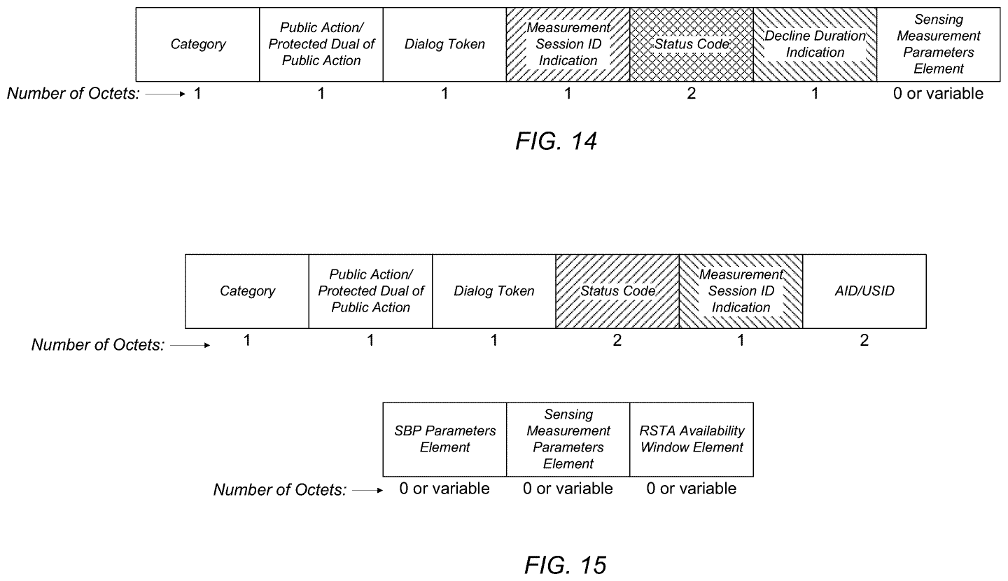

In addition to the frames discussed above, any other Sensing/SBP Action or Management Frame(s) may be used for introducing a ‘Doze Mode,’ with modifications to those frames being similar to the changes described above. For example, frames that may be used include, but are not limited to Sensing Measurement/SBP Termination frames, Sensing Query frames, Sensing Measurement/SBP Response frames, or Sensing Measurement/SBP Report frames. The following is a list of potential fields that may be used in various frames to introduce a ‘Doze Mode’ similar to what is described above for TB/Non-TB Sensing Sessions and SBP Sessions. Corresponding illustrations are shown in FIGS. 12-15.
Sensing Measurement Termination frame (1202 in FIG. 12, in reference to FIG. 9—1137g of the IEEE 802.11bf Draft 2.0 specification): the ‘Doze Mode’ indication may be part of the Measurement Session ID Indication field or the Measurement Session Termination Control field, and may include two bits. The Measurement Session Termination Control field format is shown in 1204 (in reference to FIG. 9—1137h of the IEEE 802.11bf Draft 2.0 specification,) with the Doze Mode included/defined in the Reserved section.
SBP Termination frame (1302 in FIG. 13, in reference to FIG. 9—1137i of the IEEE 802.11bf Draft 2.0 specification): the ‘Doze Mode’ indication may be part of the Measurement Session ID Indication field or SBP Termination Control field, and may include two bits. The SBP Termination Control field format is shown in 1304 (in reference to FIG. 9—1137m of the IEEE 802.11bf Draft 2.0 specification,) with the Doze Mode included/defined in the Reserved section.
Sensing Measurement Response frame (in FIG. 14, in reference to FIG. 9—1137d of the IEEE 802.11bf Draft 2.0 specification): the ‘Doze Mode’ indication may be part of the Measurement Session ID Indication field, the Decline Duration Indication field, or as a new Status Code.
SBP Response frame (in FIG. 15, in reference to FIG. 9—1137k of the IEEE 802.11bf Draft 2.0 specification): the ‘Doze Mode’ indication may be part of the Measurement Session ID Indication field or as a new Status Code.
Sensing Measurement Query frame, SBP Report frame, Sensing Measurement Report frame: may require significant modifications (inclusion of any of the mentioned/modified fields).

### New Action Frame

In some embodiments, new Action frames may be defined for the purpose of sensing session management, e.g., Sensing Session Control frame/SBP Session Control frame. The new Action frame may contain sufficient information to identify the corresponding sensing/SBP Session, e.g., by including the modified Measurement Session ID Indication field with Doze Mode bit(s).

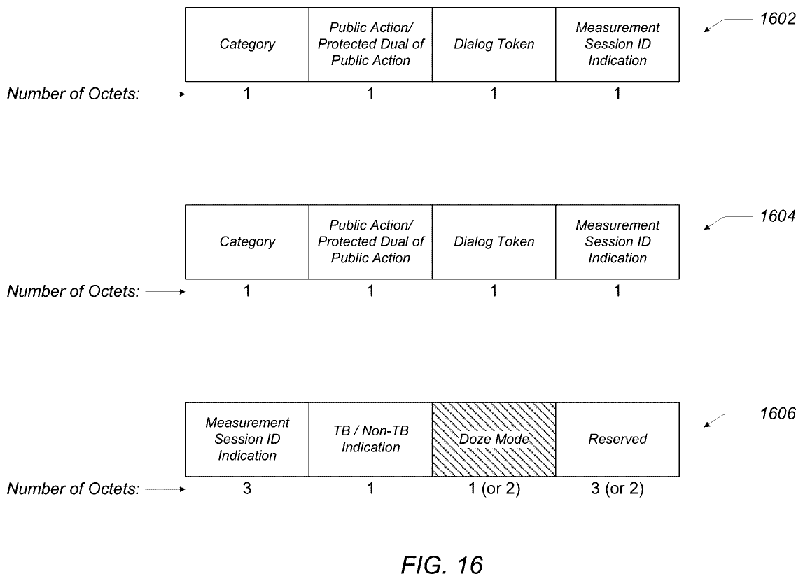

Examples are provided in FIG. 16 for a proposed Sensing Session Control frame 1602 and a proposed SBP Session Control frame 1604. For both cases, the Measurement Session ID Indication field format is illustrated in 1606, with the Doze Mode indication/field (1 or 2 bits) included.

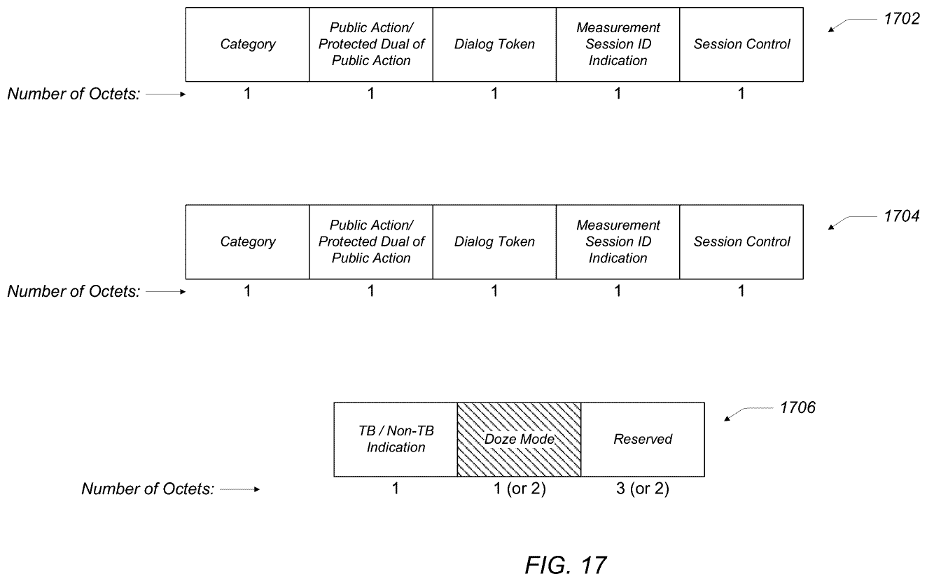

Alternatively, as shown in FIG. 17, a separate field may be included for session control in addition to the Measurement Session ID Indication field, with the Session Control field including the Doze Mode indication. Accordingly, a proposed Sensing Session Control frame 1702 and a proposed SBP Session Control frame 1704 may also include a Session Control field (1 octet) at the end. For both cases, the Session Control field format is illustrated in 1706, with the Doze Mode indication/field (1 or 2 bits) included.

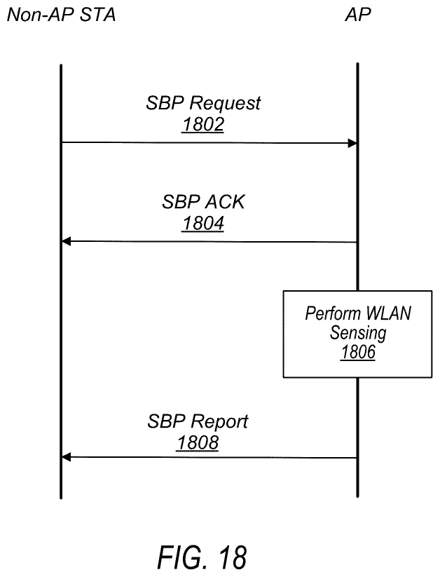

### FIG. 18—Communication Flow for Basic SBP Procedure

FIG. 18 is a communication flow diagram illustrating a method for performing a basic sensing-by-proxy (SBP) procedure, according to some embodiments. Aspects of the method of FIG. 18 may be implemented by a wireless device, such as the Access Point (AP) 112 or UE 106 illustrated in and described with respect to FIGS. 1-3, or more generally in conjunction with any of the computer circuitry, systems, devices, elements, or components shown in the Figures, among others, as desired. For example, a processor (and/or other hardware) of such a device may be configured to cause the device to perform any combination of the illustrated method elements and/or other method elements.

Note that while at least some elements of the methods of FIG. 18 are described in a manner relating to the use of communication techniques and/or features associated with IEEE 802.11 specification documents, such description is not intended to be limiting to the disclosure, and aspects of the methods of FIG. 18 may be used in any suitable wireless communication system, as desired.

In various embodiments, some of the elements of the methods shown may be performed concurrently, in a different order than shown, may be substituted for by other method elements, or may be omitted. Additional method elements may also be performed as desired. As shown, the method may proceed as follows.

At least two wireless devices (which may also be referred to herein as “wireless stations,” “stations,” or “STAs”) may establish a wireless association. The wireless association(s) may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Variations and/or other techniques for establishing an association are also possible.

At 1802, a non-AP wireless station transmits, to an AP, a request to perform a wireless local area network (WLAN) sensing operation using a basic sensing by proxy (SBP) procedure. In the basic SBP procedure, the AP may obtain sensing measurements on channel(s) between the AP and one or more non-AP STAs on behalf of the non-AP STA that requested the SBP procedure. The requesting non-AP STA may also participate as a sensing responder in the SBP procedure, to expand the sensing area, in some embodiments.

The basic SBP procedure may be driven by the SBP responder (e.g., the AP that is responding to the SBP request) or the SBP initiator (e.g., the non-AP STA that requests the SBP procedure), in various embodiments. Sensing features associated with the SBP procedure may be dictated by the SBP responder for an SBP responder driven SBP procedure, and the sensing features associated with the SBP procedure may be dictated by the SBP initiator for an SBP initiator driven SBP procedure.

In some embodiments, for the SBP responder driven SBP procedure, an SBP session is requested with parameters that include a number of respondents and a maximum sensing bandwidth. In some embodiments, for the SBP responder driven SBP procedure, the refresh rate for the SBP procedure may be indicated in an availability window element of the SBP request and may be limited to a preconfigured range of refresh rates. In some embodiments, the sensing bandwidth may be limited to be within a preconfigured range, and may be likewise indicated in the SBP request. Limiting the maximum allowable refresh rate and/or sensing bandwidth may limit the reporting overhead incurred by the AP during the SBP procedure, and the limit(s) for these parameters may be determined based on the technical capabilities of the AP, in some embodiments.

In some embodiments, for the SBP initiator driven SBP procedure, suitable sensing responders are identified and instructed prior to the sensing responders receiving a sensing request.

In some embodiments, an SBP Type of the SBP procedure is indicated by a bit field. The bit field may indicate whether the SBP procedure is a standard SBP, an SBP responder driven SBP procedure, or an SBP initiator driven SBP procedure.

In some embodiments, the AP may transmit messages to one or more non-AP STAs to request their participation as reporting STAs in the SBP procedure. The request(s) may include one or more parameters for the SBP procedure, as dictated by the SBP requester (for an SBP initiator driven SBP procedure) or the SBP responder (for an SBP responder driven procedure). In some embodiments, if one or more of the non-AP STAs reject the SBP request, the AP may respond to the SBP initiator and reject (NACK) the SBP request.

At 1804, the AP transmits, to the non-AP wireless station, an acknowledgment (ACK) or negative acknowledgment (NACK) message in response to receiving the request. The AP may transmit a positive ACK message if all participating non-AP STAs indicated that they are able to participate in the SBP procedure whereas a NACK message may be transmitted when one of the participating non-AP STAs and/or the AP are unable to participate.

At 1806, the AP performs the WLAN sensing operation to determine SBP results. The WLAN sensing operation may involve participating non-AP STAs (also referred to as SBP responders) performing sensing measurements to obtain information related to their surrounding, and providing this information (i.e., the SBP results) to the AP.

In some embodiments, the AP may pause the WLAN sensing operation to enter a doze mode. During the doze mode, no sensing frame exchanges take place between participating nodes. During the doze mode, the WLAN sensing session may not expire and may not be terminated. The AP may pause the sensing operation and enter doze mode responsive to a request received from the non-AP STA.

In some embodiments, during the doze mode, the AP may receive, from the non-AP wireless station, a second request to perform a second WLAN sensing operation using the basic SBP procedure. The first WLAN sensing operation may utilize a first periodicity different than a second periodicity of the second WLAN sensing operation. As used herein, the “periodicity” of a SBP procedure refers to the period of time between subsequent sensing measurements in the WLAN sensing operation. For example, for an SBP procedure with a first periodicity P₁, SBP responders will perform sensing measurements periodically with a period of P₁. Responsive to receiving the second request, the AP may perform the second WLAN sensing operation according to the second periodicity to product second SBP results. Advantageously, pausing the first WLAN sensing operation and performing a second WLAN sensing operation with a different periodicity may provide the non-AP STA with an efficient low-overhead method for modifying the periodicity of WLAN sensing without expending the overhead to stop the first sensing operation and restart a new one with a different periodicity. Rather, the non-AP STA may alternate pausing and resuming WLAN sensing operations with different periodicities, depending on its current sensing requirements, and a single “pause” and “resume” message may be used to modify periodicity (e.g., without exchanging request and ACK messages to start a new sensing operation and expending overhead to negotiate parameters for a new SBP procedure).

In some embodiments, the AP may exit the doze mode to resume the WLAN sensing operation. This may be performed after a specific duration of time, which may be preconfigured, or alternatively may be indicated by the non-AP STA within the pause request. Alternatively, the AP may exit the doze mode responsive to an explicit resume request received from the non-AP STA.

In various embodiments, the request to pause and/or resume doze mode for a particular SBP procedure may be transmitted in a sensing measurement request frame, an SBP request frame, a sensing measurement termination frame, a SBP termination frame, a sensing measurement response frame, and SBP response frame, a sensing measurement query frame, an SBP report frame, a sensing measurement report frame, and/or a new dedicated message frame, among other possibilities. In some embodiments, after a SBP procedure has been paused, reception of any subsequent message from the SBP initiator may cause the SBP responder to resume the SBP procedure. In some embodiments, a two bit indication may be utilized to pause and resume an SBP procedure. For example, a first bit may be used to indicate that the purpose of the message is to set the doze state, and a second bit may be used to indicate whether the state should be doze (pause) or active (resume).

At 1808, the AP transmits the SBP results to the wireless station. The SBP results may include sensing measurements describing aspects of the environment surrounding the AP and the responding non-AP STAs, and may provide information for detecting and tracking aspects of and changes in the environment.

### Various Embodiments

It should be noted that in various different options disclosed herein, the additional ‘Doze Mode’ field is added to the Measurement Session ID Indication field. However, this merely represents one approach, and in different approaches a new ‘Doze Mode Indication field may be added along with a Measurement Session ID field that contains the ‘Doze Mode’ field. It should also be noted that in case of modifications made to the Measurement Session ID Indication field, it might be beneficial to rename that field to ‘Measurement Session Management’ field, or a similarly indicative name. In general, all proposed names used herein are exemplary and may be substituted with other terms as desired.

The following paragraphs describe additional embodiments.

In some embodiments, an apparatus comprises a processor configured to cause a wireless station to perform a WLAN sensing operation comprising a WLAN sensing session, pause the WLAN sensing operation during a Doze Mode, and resume the WLAN sensing operation upon exiting the Doze Mode. In some embodiments, during Doze Mode no sensing frame exchanges take place between participating nodes, and the WLAN sensing session does not expire and is not terminated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising:
a processor configured to:
cause a wireless station to perform a wireless local area network (WLAN) sensing operation using a basic sensing by proxy (SBP) procedure driven by an SBP responder or an SBP initiator;
wherein sensing features associated with the SBP procedure are dictated by the SBP responder for an SBP responder driven SBP procedure, and wherein the sensing features associated with the SBP procedure are dictated by the SBP initiator for an SBP initiator driven SBP procedure.

2. The apparatus of claim 1, wherein for the SBP responder driven SBP procedure, the processor transmits an SBP request to the wireless station with parameters that include a number of respondents and a maximum sensing bandwidth.

3. The apparatus of claim 2, wherein a maximum refresh rate indicated in an availability window element is limited.

4. The apparatus of claim 2, wherein the maximum sensing bandwidth is limited.

5. The apparatus of claim 1, wherein for the SBP initiator driven SBP procedure, the processor is further configured to:
determine one or more sensing responders prior to causing the wireless station to perform the WLAN sensing operation; and
wherein the wireless station is one of the determined one or more sensing responders, and wherein causing the wireless station to perform the WLAN sensing operation comprises transmitting a SBP request to the wireless station.

6. The apparatus of claim 1,
wherein the processor is further configured to:
pause the WLAN sensing operation to enter a doze mode, wherein during the doze mode no sensing frame exchanges take place between participating nodes; and
exit the doze mode to resume the WLAN sensing operation.

7. The apparatus of claim 6,
wherein, during the doze mode, the WLAN sensing session does not expire and is not terminated.

8. The apparatus of claim 1,
wherein an SBP Type of the SBP procedure is indicated by a bit field, wherein the bit field indicates whether the SBP procedure comprises:
a standard SBP;
the SBP responder driven SBP procedure; or
the SBP initiator driven SBP procedure.

9. A wireless access point (AP), comprising:
a radio;
a processor operably coupled to the radio and configured to:
receive, from a wireless station, a request to perform a wireless local area network (WLAN) sensing operation using a basic sensing by proxy (SBP) procedure driven by an SBP responder or an SBP initiator, wherein sensing features associated with the SBP procedure are dictated by the SBP responder for an SBP responder driven SBP procedure, and wherein the sensing features associated with the SBP procedure are dictated by the SBP initiator for an SBP initiator driven SBP procedure;
transmit, to the wireless station, an acknowledgment message in response to receiving the request; and
perform the WLAN sensing operation to determine SBP results; and
transmit the SBP results to the wireless station.

10. The wireless AP of claim 9, wherein for the SBP responder driven SBP procedure, an SBP session is requested with parameters that include a number of respondents and a maximum bandwidth.

11. The wireless AP of claim 10, wherein a maximum refresh rate indicated in an availability window element is limited.

12. The wireless AP of claim 10, wherein a maximum sensing bandwidth is limited.

13. The wireless AP of claim 9, wherein for the SBP initiator driven SBP procedure, suitable sensing responders are identified and instructed prior to the sensing responders receiving a sensing request.

14. The wireless AP of claim 9,
wherein the processor is further configured to:
pause the WLAN sensing operation to enter a doze mode, wherein during the doze mode no sensing frame exchanges take place between participating nodes; and
exit the doze mode to resume the WLAN sensing operation.

15. The wireless AP of claim 14,
wherein, during the doze mode, the WLAN sensing session does not expire and is not terminated.

16. The wireless AP of claim 14,
during the doze mode:
receive, from the wireless station, a second request to perform a second WLAN sensing operation using the basic SBP procedure, wherein the first WLAN sensing operation utilizes a first periodicity different than a second periodicity of the second WLAN sensing operation; and
perform the second WLAN sensing operation according to the second periodicity to product second SBP results.

17. The wireless AP of claim 9,
wherein an SBP Type of the SBP procedure is indicated by a bit field, wherein the bit field indicates whether the SBP procedure comprises:
a standard SBP;
the SBP responder driven SBP procedure; or
the SBP initiator driven SBP procedure.

18. A method, comprising:
by a wireless station:
transmitting a sensing by proxy (SBP) request message to a wireless access point (AP) to request that the wireless AP performs a wireless local area network (WLAN) sensing operation using a basic SBP procedure driven by an SBP responder or an SBP initiator, wherein sensing features associated with the SBP procedure are dictated by the SBP responder for an SBP responder driven SBP procedure, and wherein the sensing features associated with the SBP procedure are dictated by the SBP initiator for an SBP initiator driven SBP procedure;
receiving an acknowledgment message from the wireless AP indicating whether the wireless AP will perform the basic SBP procedure; and
receiving SBP results from the wireless AP indicating sensing measurement results of the WLAN sensing operation.

19. The method of claim 18, further comprising:
transmitting a pause request to the wireless AP to pause the WLAN sensing operation;
after transmitting the paus request, transmitting a second SBP request message to the wireless AP to request that the wireless AP resumes a second WLAN sensing operation;
receiving second SBP results from the wireless AP indicating second sensing measurement results of the second WLAN sensing operation; and
after receiving the second sensing measurement results, transmit instructions to the wireless AP to resume the WLAN sensing operation.

20. The method of claim 19,
wherein the WLAN sensing operation utilizes a different periodicity than the second WLAN sensing operation.
